(19) United States
(12) Patent Application Publication
(10) Pub. No.: US 2025/0259635 A1
(43) Pub. Date: Aug. 14, 2025

(54) APPARATUS FOR DETECTING FORGERY OF VOICE FILE AND METHOD THEREOF

(71) Applicants: SSMM INC., Seoul (KR); FOUNDATION OF SOONGSIL UNIVERSITY-INDUSTRY COOPERATION, Seoul (KR)

(72) Inventor: Jae Wan PARK, Seoul (KR)

(73) Assignees: SSMM INC., Seoul (KR); FOUNDATION OF SOONGSIL UNIVERSITY-INDUSTRY COOPERATION, Seoul (KR)

(21) Appl. No.: 18/286,759

(22) PCT Filed: Oct. 27, 2022
(86) PCT No.: PCT/KR2022/016527

§ 371 Date: May 1, 2025

(51) Int. Cl. G10L 17/26; G10L 17/02; G10L 17/06; G10L 25/18

(52) U.S. Cl. CPC G10L 17/26; G10L 17/02; G10L 17/06; G10L 25/18

(57) ABSTRACT

An apparatus for detecting forgery of voice file using a specific pronunciation includes a receiver configured to receive a recorded voice file through a user terminal, a preprocessor configured to output the received voice file in a form of a graph consisting of a time axis and a frequency axis and configured to independently amplify a specific transition band in the output graph, a signal detector configured to extract an unusual signal and configured to extract a voice waveform corresponding to an aspirated sound or an alveolar-palatal frication sound, a forgery determination unit configured to analyze a correlation between the unusual signal and the voice waveform and configured to determine whether the voice file is forged according to an analysis results, and a controller configured to mark a portion where there is forgery and display the marked portion on a screen when the voice file is determined to be forged.

### TECHNICAL FIELD

The present invention relates to an apparatus for detecting forgery of voice file and a method thereof, and particularly to an apparatus for detecting forgery of voice file and a method thereof that amplify a transition band in a recorded voice file by using a user terminal and determine whether an air blowing phenomenon disappears from an aspirated sound or an alveolar-palatal frication sound or whether the air blowing phenomenon occurs from a sound other than the aspirated sound or the alveolar-palatal frication sound by using the amplified transition band to detect whether the voice file is forged.

### BACKGROUND ART

Sophisticated forgery may be made through mass duplication, digital editing programs, and the like from an original file due to the nature of digital audio files, and thereby, the number of cases of digital audio file manipulation is increasing.

In addition, recently, precise audio editing has been made easily by not only experts but also general persons because partial selection, cut, copy, or a mixed paste may be made syllable by syllable in a digital audio file with only a few clicks like photoshop while various audio editors that provide audio visualization functions, such as spectrogram are provided.

When a digital audio file to be edited is not recorded in the same environment in an audio editing method, a compressor is performed to remove noise and provide the same sense of space and a clear sound after a mixed paste is performed.

The mixed paste automatically reduces breathing sounds, aspirated sounds, or alveolar-palatal frication sounds and also reduces ambient noise and includes features that reduce awkward sense of space. Furthermore, the compressor has an effect that deals with a pattern envelope of a unique volume change of sounds, and when this technology is applied, a frequency shift phenomenon occurs in a front attack where the compressor is applied according to a principle of ADSR (attack, decay, sustain, and release).

In addition, when a mixed paste and a compressor are used, a minute differences occurs in a spectrogram. However, the known forgery detection method has limitations in determining whether the minute difference occurs naturally or due to artificial editing.

Also, in the related art, forgery of audio files are detected by using electrical network frequency (ENF), but audio editing using the mixed paste may be synthesized without disturbing an audible frequency range. In addition, it is generally considered that there is no editing when overlapping sounds between speakers occur, but it is possible to generate overlapping sounds between speakers by using this.

Furthermore, in recent call recordings of user terminals, low-band signals are removed through preprocessing, and accordingly, there is a problem in that it is almost impossible to detect an ENF signal from the actual recorded digital audio file.

In addition, a method of automatically detecting forgery sections of audio signals only considers characteristics of background noise caused by voice insertion, and accordingly, it is difficult for the method to be applied to audio files in which voice sections were removed or a mixed paste was performed, and there is a limitation in determining whether there is forgery.

A technology behind the present invention is disclosed in Korean Patent No. 10-1382356 (published on Jan. 10, 2014).

### DISCLOSURE OF THE INVENTION

### Technical Problem

The present invention provides an apparatus for detecting forgery of voice file and a method thereof that amplify a transition band in a recorded voice file by using a user terminal and determine whether an air blowing phenomenon disappears from an aspirated sound or an alveolar-palatal frication sound or whether the air blowing phenomenon occurs from a sound other than the aspirated sound or the alveolar-palatal frication sound by using the amplified transition band to detect whether a corresponding voice file is forged.

### Technical Solution

According to an embodiment of the present invention, an apparatus for detecting forgery of voice file, which uses a voice waveform for a specific pronunciation, includes a receiver configured to receive a recorded voice file through a user terminal, a preprocessor configured to output the received voice file in a form of a graph consisting of a time axis and a frequency axis and configured to independently amplify a specific transition band in the output graph, a signal detector configured to extract an unusual signal according to an air blowing phenomenon in the specific transition band and configured to extract a voice waveform corresponding to an aspirated sound or an alveolar-palatal frication sound, a forgery determination unit configured to analyze a correlation between the unusual signal and the voice waveform and configured to determine whether the voice file is forged according to an analysis results, and a controller configured to mark a portion where there is forgery and display the marked portion on a screen when the voice file is determined to be forged.

The forgery determination unit may determine forgery by determining whether an unusual signal is detected in a section that matches the voice waveform corresponding to the aspirated sound or alveolar-palatal frication sound.

The forgery determination unit may determine that there is forgery by performing a mixed paste of a spectrum corresponding to a section occurring in the aspirated sound or alveolar-palatal frication sound included in the same voice file or another voice file into a corresponding section when the unusual signal is not detected.

The forgery determination unit may determine that there is forgery by performing a mixed paste of a spectrum corresponding to a section occurring in an aspirated sound or alveolar palatal frication sound included in the same voice file or another voice file into a corresponding section and by applying a compressor when the unusual signal is detected and a spectrum for the unusual signal is output irregularly.

The forgery determination unit may compare a difference value between a magnitude of an unusual signal corresponding to the same aspirated sound or alveolar-palatal frication sound and the unusual signal with a reference value when the unusual signal is detected, and determine that there is forgery by performing a mixed paste of a spectrum corresponding to a section occurring in the aspirated sound or alveolar-palatal frication sound that is included in the same voice file or another voice file and is uttered by another person into a corresponding section when the difference value is greater than the reference value.

The forgery determination unit may determine whether the unusual signal is detected in a section that matches a voice waveform corresponding to a sound other than the aspirated sound and alveolar-palatal frication sound, and determine that there is forgery by performing a mixed paste of a spectrum corresponding to a section in which a sound other than the aspirated sound or alveolar-palatal frication sound included in the same voice file or another voice file is generated into a corresponding section when the unusual signal is detected.

According to another embodiment of the present invention, a forgery detection method using an apparatus for detecting forgery of voice file includes receiving a recorded voice file through a user terminal, outputting the received voice file in a form of a graph consisting of a time axis and a frequency axis and independently amplifying a specific transition band in the output graph, extracting an unusual signal according to an air blowing phenomenon in the specific transition band and extracting a voice waveform corresponding to an aspirated sound or an alveolar-palatal frication sound, analyzing a correlation between the unusual signal and the voice waveform and determining whether the voice file is forged according to an analysis results, and marking a portion where there is forgery and displaying the marked portion on a screen when the voice file is determined to be forged.

### Advantageous Effects

In this way, according to the present invention, a transition band may be independently amplified from a voice file output in the form of a graph, forgery may be determined by using an air blowing phenomenon occurring in the amplified transition band, and accordingly, forgery may be detected even in a voice file obtained by performing a mixed paste and a compression, and an editing section of the voice file may be objectively detected, and the voice file may be used as objective evidence.

In addition, according to an embodiment of the present invention, an aspirated sound or alveolar-palatal friction sound is uttered differently for each person depending on an oral structure or the amount of air discharged from the lung, and an air blowing phenomenon occurring in response thereto is also output differently, and accordingly, whether a person's voice is synthesized or whether the voice is recorded in another space may be determined and the physical time required to analyze audio files and costs associated with employed experts may be reduced.

### BRIEF DESCRIPTION OF THE DRAWINGS

FIG. 1 is a configuration diagram illustrating an apparatus for detecting forgery of voice file, according to an embodiment of the present invention.

FIG. 2 is a flow chart illustrating a forgery detection method using an apparatus for detecting forgery of voice file, according to an embodiment of the present invention.

FIG. 3 is an example view illustrating a state in which a voice file is output as a graph in step S220 illustrated in FIG. 2.

FIG. 4 is an example view illustrating an unusual signal detected in step 230 illustrated in FIG. 2.

FIG. 5 is an example view illustrating a state in which an unusual signal is removed by performing a mixed paste on a voice file, according to an embodiment of the present invention.

FIG. 6 is an example view illustrating a state in which an irregular unusual signal is detected by using a compressor after performing a mixed paste on an aspirated sound or an alveolar-palatal frication sound of a voice file, according to an embodiment of the present invention.

FIG. 7 is an example view illustrating a state in which an irregular unusual signal is detected by using a compressor after performing a mixed paste on an aspirated sound of a voice file or a sound that is not an alveolar-palatal frication sound, according to an embodiment of the present invention.

FIG. 8 is an example view illustrating a state in which another person's voice is mixed and pasted in a voice file, according to an embodiment of the present invention.

### DETAILED DESCRIPTION OF THE EMBODIMENTS

Hereinafter, preferred embodiments according to the present invention will be described in detail with reference to the attached drawings. In this process, thicknesses of lines or sizes of components illustrated in the drawings may be exaggerated for clarity and convenience of description.

In addition, the terms described below are terms defined in consideration of functions in the present invention and may change depending on intention or custom of a user or an operator. Therefore, definitions of the terms should be made based on the content throughout the present specification.

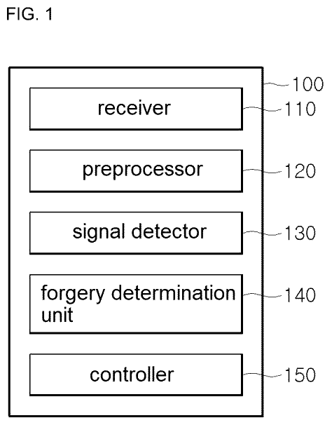

Hereinafter, an apparatus for detecting forgery of voice file, according to an embodiment of the present invention, will be described in more detail with reference to FIG. 1.

FIG. 1 is a configuration diagram illustrating an apparatus for detecting forgery of voice file, according to an embodiment of the present invention.

As illustrated in FIG. 1, an apparatus for detecting forgery of voice file 100 according to an embodiment of the present invention includes a receiver 110, a preprocessor 120, a c 130, a forgery determination unit 140, and a controller 150.

First, the receiver 110 receives a voice file for detecting forgery. In this case, the voice file is recorded by using a user terminal.

Next, the preprocessor 120 converts the received voice file into a graph and independently amplifies a transition band in the converted graph.

Also, the preprocessor 120 outputs the voice file in a graph in which characteristics of a waveform and a spectrum are combined. Here, the waveform represents a change in amplitude axis according to a change in time axis, the spectrum represents a change in amplitude axis according to a change in frequency axis, and the change in amplitude axis is represented as a difference in density or display color.

Next, the preprocessor 120 extracts a transition band from the output graph, amplifies the extracted transition band, and outputs a spectrum in the transition band.

The signal detector 130 detects a voice waveform corresponding to an aspirated sound and an alveolar-palatal frication sound. In addition, the signal detector 130 detects an unusual signal resulting from an air blowing phenomenon, from the amplified transition band.

Then, the forgery determination unit 140 determines whether a corresponding voice file is forged by using the detected voice waveform and the unusual signal.

Also, the aspirated sound or alveolar-palatal friction sound causes an air blowing phenomenon. Therefore, the forgery determination unit 140 determines whether an unusual signal is generated in a section that matches a voice waveform corresponding to the aspirated sound or the alveolar-palatal frication sound, and determines that forgery is not made in the corresponding voice file when the unusual signal is generated.

Meanwhile, when an unusual signal is not generated in the section that matches the voice waveform corresponding to the aspirated sound or the alveolar-palatal frication sound, the forgery determination unit 140 determines that forgery is made in a corresponding voice file.

In addition, when an unusual signal is generated in a section that matches a voice waveform corresponding to a sound other than an aspirated sound or an alveolar-palatal frication sound, the forgery determination unit 140 determines that forgery is made in a corresponding voice file.

Finally, the controller 140 marks a section where forgery is made and displays the marked section on a screen.

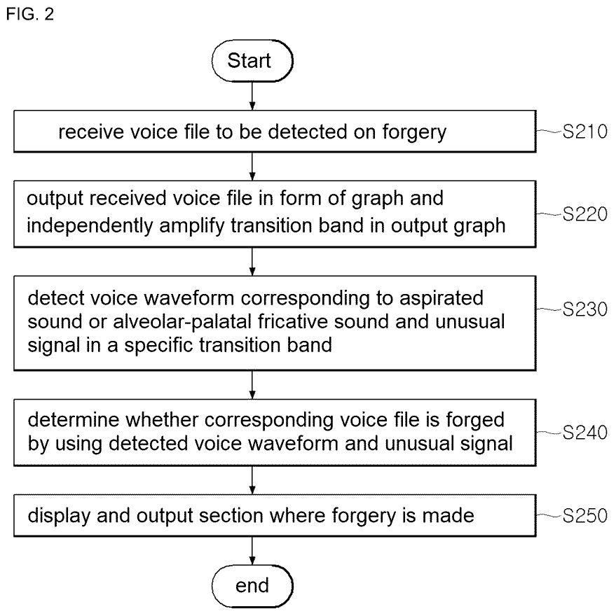

Hereinafter, a forgery detection method using the apparatus for detecting forgery of voice file 100 according to an embodiment of the present invention will be described in more detail with reference to FIGS. 2 to 8.

FIG. 2 is a flowchart illustrating a forgery detection method using an apparatus for detecting forgery of voice file, according to an embodiment of the present invention.

As illustrated in FIG. 2, the apparatus for detecting forgery of voice file 100 according to an embodiment of the present invention receives a voice file to detect whether there is forgery (S210).

Also, the receiver 110 receives a voice file recorded through a user terminal.

The apparatus for detecting forgery of voice file 100 according to an embodiment of the present invention determines whether a corresponding voice file is forged by using an air blowing phenomenon that occurs when an aspirated sound or an alveolar-palatal frication sound is uttered.

When recording voice by using a user terminal, a low-pass filter or band-pass filter is used, and in a frequency range where the low-pass filter or the band-pass filter is applied, an air blowing phenomenon generated in response to an aspirated sound or an alveolar-palatal frication sound is recorded.

Here, the aspirated sound is a sound made by a strong burst of wind when a plosive sound is made and is called a harsh sound (“ts”, “k”, “t”, “p”) in Korean phonology. The alveolar-palatal frication sound is a sound made by using friction that occurs as air passes through a narrow gap when pronouncing a consonant. When “s” or “ss” is before /i or j/, an air blowing phenomenon occurs.

Meanwhile, the air blowing phenomenon may also occur when pronouncing a sound such as “kk”, “tt”, “pp”, or “zz” according to an oral structure or characteristics of a speaker. Therefore, the apparatus for detecting forgery of voice file 100 according to an embodiment of the present invention may also determine whether a corresponding voice file is forged by using the air blowing phenomenon generated from a tense sound other than an aspirated sound or an alveolar-palatal frication sound, depending on user's needs.

Therefore, in the embodiment of the present invention, forgery is analyzed by using a voice file recorded through a user terminal.

Next, the preprocessor 120 outputs the received voice file in the form of a graph and independently amplifies the transition band in the output graph (S220).

Also, the preprocessor 120 outputs sounds or waves included in the voice file as a graph to visualize the sounds or waves.

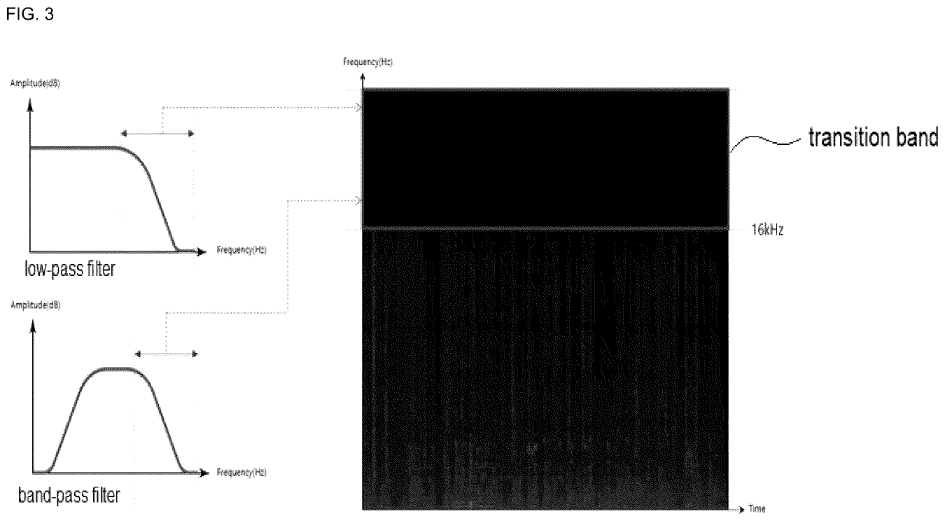

FIG. 3 is an example view illustrating a state in which a voice file is output as a graph in step S220 illustrated in FIG. 2.

As illustrated in FIG. 3, the X axis of the graph denotes a time axis, and the Y axis denotes a frequency axis. The graph illustrates a difference in amplitude according to changes in the time axis and frequency axis as a difference in density and color.

Meanwhile, the low-pass filter or band-pass filter applied to the voice file may not completely block signals, and accordingly, a transition band is formed between the low-pass filter or band-pass filter and a cutoff band, and an air blowing phenomenon caused by an aspirated sound or an alveolar-palatal frication sound is recorded in the transition band.

However, the transition band is narrow, and accordingly, there are limitations in distinguishing unusual signals due to the air blowing phenomenon.

Therefore, the preprocessor 120 independently amplifies a specific transition band.

Next, the signal detector 130 detects a voice waveform corresponding to an aspirated sound or an alveolar-palatal frication sound and detects an unusual signal in a specific transition band (S230).

First, the signal detector 130 detects a voice waveform corresponding to an aspirated sound or an alveolar-palatal frication sound among the voice waveforms. Then, the signal detector 130 detects an unusual signal in the transition band.

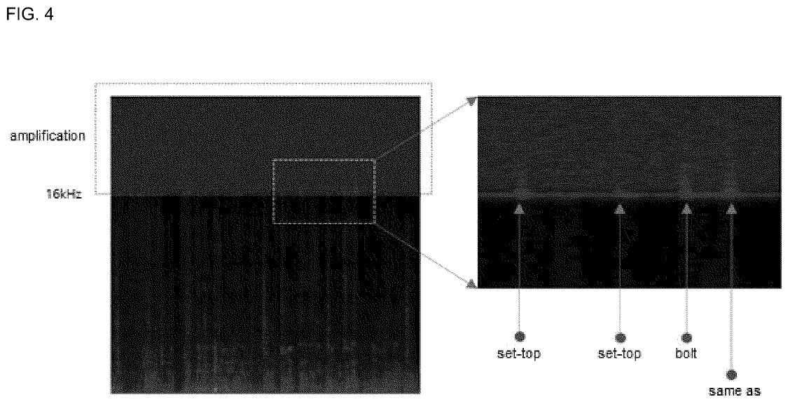

FIG. 4 is an example view illustrating an unusual signal detected in step 230 illustrated in FIG. 2.

As illustrated in FIG. 4, the signal detector 130 amplifies the transition band to detect an unusual signal corresponding to an aspirated sound, such as “set-top” and “bolt”, and an unusual signal corresponding to an alveolar-palatal frication sound, such as “same as”.

When step S230 is completed, the forgery determination unit 140 determines whether the corresponding voice file is forged by using the detected voice waveform and unusual signal (S240).

When a voice file is not forged, an unusual signal is detected in the transition band that matches a voice waveform corresponding to an aspirated sound or an alveolar-palatal frication sound.

Therefore, the forgery determination unit 140 determines whether there is forgery by using whether an unusual signal is detected in a transition band that matches a voice waveform corresponding to an aspirated sound or alveolar-palatal frication sound.

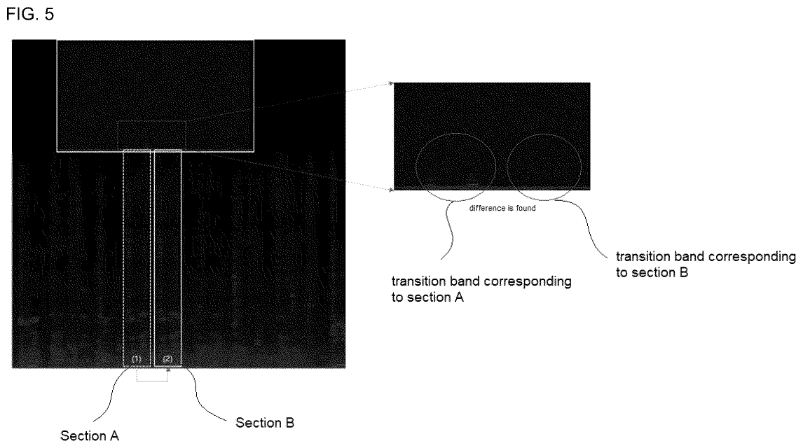

Hereinafter, the forgery determination method according to an embodiment of the present invention will be described in more detail with reference to FIGS. 5 to 8.

FIG. 5 is an example view illustrating a state in which an unusual signal is removed by performing a mixed paste on a voice file according to an embodiment of the present invention.

As illustrated in FIG. 5, a section A represents a spectrum corresponding to a section in which an aspirated sound or an alveolar-palatal frication sound is generated, and a section B represents a spectrum corresponding to a section in which a sound other than the aspirated sound or alveolar-palatal frication sound is generated.

In addition, it is assumed that forgery is made by copying the section A and performing a mixed paste of the section A to the section B. Meanwhile, the mixed paste is performed by copying only a spectrum in a low-pass filter or band-pass filter and pasting the copied spectrum into others.

Therefore, the forgery determination unit 140 determines that the corresponding voice file is forged because no unusual signal is detected in the transition band corresponding to the section B.

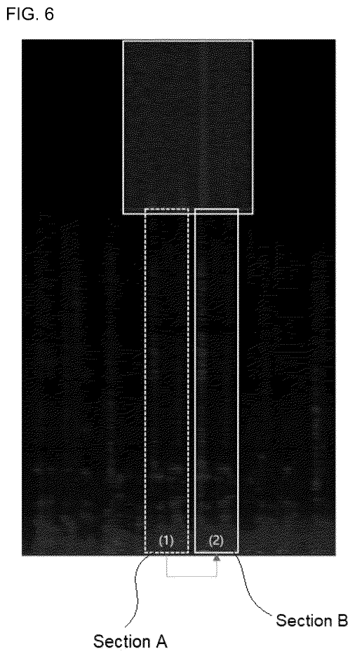

FIG. 6 is an example view illustrating a state in which an irregular unusual signal is detected by using a compressor after performing a mixed paste on an aspirated sound or an alveolar-palatal frication sound of a voice file according to an embodiment of the present invention.

As illustrated in FIG. 6, a section A is a spectrum corresponding to a section in which an aspirated sound or an alveolar-palatal frication sound is generated, and a section B is a spectrum corresponding to a section in which a sound other than the aspirated sound or alveolar-palatal frication sound is generated.

In addition, it is assumed that forgery is made by using a compressor after a forger copies the section A and performs a mixed paste of the copied section A into the section B.

As illustrated in FIG. 6, an unusual signal is detected in both a transition band corresponding to the section A and a transition band corresponding to the section B, but when the unusual signal in the transition band corresponding to the section B is irregular, the forgery determination unit 140 determines that forgery is made in the section B.

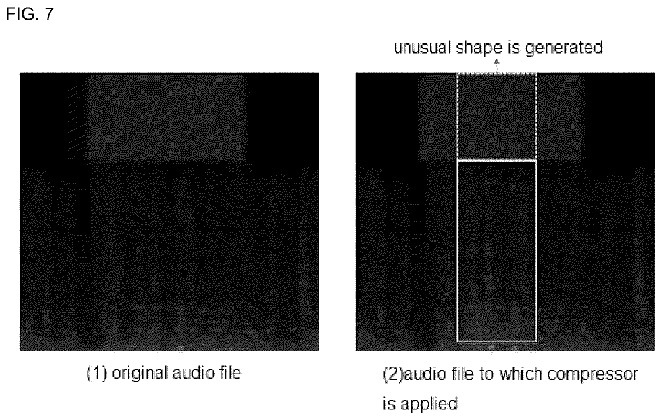

FIG. 7 is an example view illustrating a state in which an irregular unusual signal is detected by using a compressor after performing a mixed paste on a sound other than an aspirated sound or an alveolar-palatal frication sound of a voice file according to an embodiment of the present invention.

As illustrated in FIG. 7, when encoding is performed by using a compressor, air blowing may be generated even in a sound other than an aspirated sound or an alveolar-palatal frication sound. Therefore, when the detected unusual signal is output with a higher spectrum than other unusual signals, the forgery determination unit 140 determines that forgery is made in which a compressor is applied to a corresponding voice file.

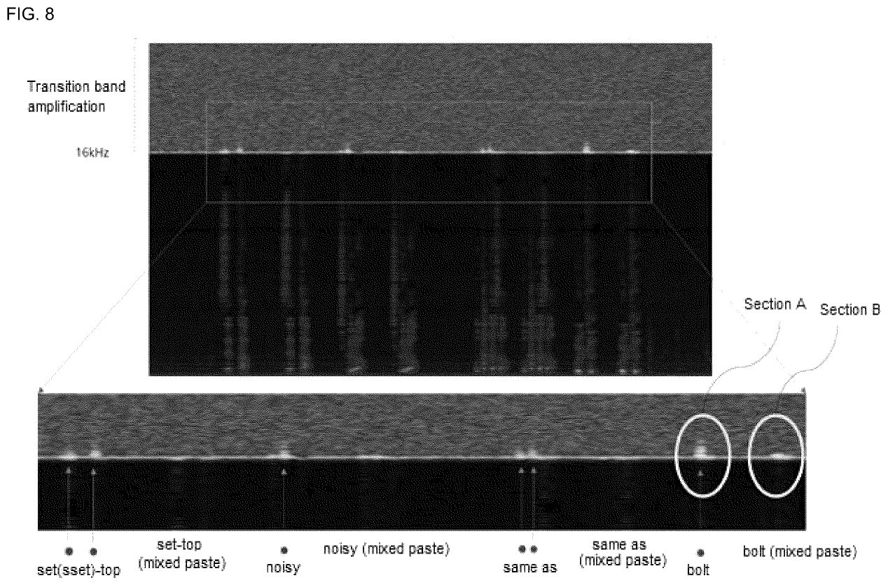

FIG. 8 is an example view illustrating a state in which another person's voice is mixed and pasted in a voice file according to an embodiment of the present invention.

As illustrated in FIG. 8, the forgery determination unit 140 sets a reference value for an unusual signal. Next, when a plurality of unusual signals corresponding to “volt” are detected, the forgery determination unit 140 calculates a difference value between an unusual signal in a section A and an unusual signal in a section B, and compares the calculated difference value with the reference value.

In addition, when the calculated difference value is greater than the reference value, the forgery determination unit 140 determines that a speaker in the section A is different from a speaker in the section B and determines that a corresponding voice file is forged.

When it is determined in step S240 that forgery is made in a corresponding voice file, the controller 150 marks a portion where there is the forgery and displays the marked portion on a screen.

Also, there may be forgery in a specific section as in the example described in step S240. Then, the controller 150 marks a specific section and displays the marked section on a screen, which allows a user to visually recognize whether a voice file is forged.

As such, the apparatus for detecting forgery of voice file, according to an embodiment of the present invention, may independently amplify a transition band from a voice file output in the form of a graph and determine forgery by using an air blowing phenomenon occurring in the amplified transition band, and accordingly, forgery may be detected even in a voice file obtained by performing a mixed paste and a compression, an editing section of the voice file may be objectively detected, and the voice file may be used as objective evidence.

In addition, the apparatus for detecting forgery of voice file, according to the embodiment of the present invention, may determine whether a person's voice is synthesized or whether the voice is recorded in another space because an aspirated sound or alveolar-palatal friction sound is uttered differently for each person depending on an oral structure or the amount of air discharged from the lung and a corresponding air blowing phenomenon is also output differently, and may reduce the physical time required to analyze audio files and reduce costs associated with employed experts.

The present invention is described with reference to the embodiments illustrated in the drawings, but the embodiments are merely illustrative, and those skilled in the art to which the present invention belongs will understand that various modifications and other equivalent embodiments may be derived therefrom. Therefore, the true technical protection scope of the present invention should be determined by the technical idea of the claims below.

### REFERENCE SIGNS LIST

100: apparatus for detecting forgery of voice file
110: receiver
120: preprocessor
130: signal detector
140: forgery determination unit
150: controller

1. An apparatus for detecting forgery of voice file, which uses a voice waveform for a specific pronunciation, the apparatus comprising:
a receiver configured to receive a recorded voice file through a user terminal;
a preprocessor configured to output the received voice file in a form of a graph consisting of a time axis and a frequency axis and configured to independently amplify a specific transition band in the output graph;
a signal detector configured to extract an unusual signal according to an air blowing phenomenon in the specific transition band and configured to extract a voice waveform corresponding to an aspirated sound or an alveolar-palatal frication sound;
a forgery determination unit configured to analyze a correlation between the unusual signal and the voice waveform and configured to determine whether the voice file is forged according to an analysis results; and
a controller configured to mark a portion where there is forgery and display the marked portion on a screen when the voice file is determined to be forged.

2. The apparatus of claim 1, wherein
the forgery determination unit determines forgery by determining whether an unusual signal is detected in a section that matches the voice waveform corresponding to the aspirated sound or alveolar-palatal frication sound.

3. The apparatus of claim 2, wherein
the forgery determination unit determines that there is forgery by performing a mixed paste of a spectrum corresponding to a section occurring in the aspirated sound or alveolar-palatal frication sound included in the same voice file or another voice file into a corresponding section when the unusual signal is not detected.

4. The apparatus of claim 2, wherein
the forgery determination unit determines that there is forgery by performing a mixed paste of a spectrum corresponding to a section occurring in an aspirated sound or alveolar palatal frication sound included in the same voice file or another voice file into a corresponding section and by applying a compressor when the unusual signal is detected and a spectrum for the unusual signal is output irregularly.

5. The apparatus of claim 2, wherein
the forgery determination unit compares a difference value between a magnitude of an unusual signal corresponding to the same aspirated sound or alveolar-palatal frication sound and the unusual signal with a reference value when the unusual signal is detected, and determines that there is forgery by performing a mixed paste of a spectrum corresponding to a section occurring in the aspirated sound or alveolar-palatal frication sound that is included in the same voice file or another voice file and is uttered by another person into a corresponding section when the difference value is greater than the reference value.

6. The apparatus of claim 2, wherein
the forgery determination unit determines whether the unusual signal is detected in a section that matches a voice waveform corresponding to a sound other than the aspirated sound and alveolar-palatal frication sound, and determines that there is forgery by performing a mixed paste of a spectrum corresponding to a section in which a sound other than the aspirated sound or alveolar-palatal frication sound included in the same voice file or another voice file is generated into a corresponding section when the unusual signal is detected.

7. A forgery detection method using an apparatus for detecting forgery of voice file, the forgery detection method comprising:
receiving a recorded voice file through a user terminal;
outputting the received voice file in a form of a graph consisting of a time axis and a frequency axis and independently amplifying a specific transition band in the output graph;
extracting an unusual signal according to an air blowing phenomenon in the specific transition band and extracting a voice waveform corresponding to an aspirated sound or an alveolar-palatal frication sound;
analyzing a correlation between the unusual signal and the voice waveform and determining whether the voice file is forged according to an analysis results; and
marking a portion where there is forgery and displaying the marked portion on a screen when the voice file is determined to be forged.

8. The forgery detection method of claim 7, wherein, in the determining whether the voice file is forged,
whether there is forgery is determined by determining whether an unusual signal is detected in a section that matches the voice waveform corresponding to the aspirated sound or alveolar-palatal frication sound.

9. The forgery detection method of claim 8, wherein, in the determining whether the voice file is forged,
forgery is determined to be there by performing a mixed paste of a spectrum corresponding to a section occurring in the aspirated sound or alveolar-palatal frication sound included in the same voice file or another voice file into a corresponding section when the unusual signal is not detected.

10. The forgery detection method of claim 9, wherein, in the determining whether the voice file is forged,
forgery is determined to be there by performing a mixed paste of a spectrum corresponding to a section occurring in an aspirated sound or alveolar palatal frication sound included in the same voice file or another voice file into a corresponding section and by applying a compressor when the unusual signal is detected and a spectrum for the unusual signal is output irregularly.

11. The forgery detection method of claim 8, wherein, in the determining whether the voice file is forged,
a difference value between a magnitude of an unusual signal corresponding to the same aspirated sound or alveolar-palatal frication sound and the unusual signal is compared with a reference value when the unusual signal is detected, and
forgery is determined to be there by performing a mixed paste of a spectrum corresponding to a section occurring in the aspirated sound or alveolar-palatal frication sound that is included in the same voice file or another voice file and is uttered by another person into a corresponding section when the difference value is greater than the reference value.

12. The forgery detection method of claim 8, wherein, in the determining whether the voice file is forged,
whether the unusual signal is detected in a section that matches a voice waveform corresponding to a sound other than the aspirated sound and alveolar-palatal frication sound is determined, and
forgery is determined to be there by performing a mixed paste of a spectrum corresponding to a section in which a sound other than the aspirated sound or alveolar-palatal frication sound included in the same voice file or another voice file is generated into a corresponding section when the unusual signal is detected.
